(19) United States
(12) Patent Application Publication
(10) Pub. No.: US 2010/0287908 A1
(43) Pub. Date: Nov. 18, 2010

(54) Jet engine shield and debris deflector

(76) Inventor: Ray E. Cunningham, Monroe, GA (US)

Correspondence Address: Ray E. Cunningham, 568 Highway 11 S.W., Monroe, GA, 30655, US

(21) Appl. No.: 12/454,365

(22) Filed: May 18, 2009

(51) Int. Cl. F02G 3/00

(52) U.S. Cl. 60/39.092

(57) ABSTRACT

A jet engine bird and debris shield device is disclosed that is designed as a deflector to deflect large birds, such as geese weighing in excess of eight pounds, and keep from entering the turbine blades of a jet engine. The shield device is aerodynamically shaped in the form of a frustro-conical cylinder aligned to the direction of flight and attaches to the air intake portion of the jet engine. The shield is formed with a series of openings or slots that allow sufficient air to be entrained into the jet engine intake. The orientation and shape of the slots direct the air directly to the turbine blades of the engine.

### CROSS REFERENCE TO RELATED APPLICATIONS

Not Applicable

### BACKGROUND

1. Field of Invention

The present invention relates to aircraft safety and in particular to a jet engine shield and debris deflector.

### FEDERALLY SPONSORED RESEARCH

Not Applicable

### SEQUENCE LISTING OR PROGRAM

Not Applicable

2. Prior Art

It is a fairly common occurrence for jet aircraft to be struck by flying debris resulting in serious damage; particularly should this material be ingested into the air intake of a jet engine. This most often occurs when a large bird, such as a large goose, or flock of birds are encountered in the flight path of the aircraft. In the past 20 years it is estimated that there have been between 80,000 and 100,000 bird collisions with aircraft. The resulting damage from these collisions can disable the engine causing the aircraft to be forced to attempt to make an emergency landing resulting in, or in a worse case scenario, causing the aircraft to crash. In addition to compromising the safety and risking the lives of the passengers and crew, the loss of aircraft equipment runs into vast sums of money. This creates a lack of confidence by the public in the safety of flying. In addition it is a common occurrence for the air intake of a jet engine to ingest small and sometimes large articles while the aircraft is on the ground.

Various structures have been made in an attempt to prevent this damage to jet engines but none of these have been incorporated into conventional civilian or commercial jet aircraft. A number of these prior art structures are disclosed in the following U.S. patents of interest.

U.S. Pat. No. 3,196,598 to Olson discloses an inlet deflector for a jet engine formed of a series of rods formed in a conical configuration.

U.S. Pat. No. 5,411,224 to Dearman relates to protective guards and covers for jet engines formed of shaped titanium rods that extend forward and at an inclined angle of 30 degrees.

U.S. Pat. No. 4,149,689 to McDonald relates to a protective screen for jet engine air intakes formed of a conical cage using an array of metal rods held by a solid tip and a cone base.

U.S. Pat. Des. 433,029 to Eidson shows a jet engine intake deflection guard that is frustro-conical in shape formed of a screen at the forward distal end and a series of mounting rods at the rearward proximate end.

U.S. Pat. No. 2,969,941 to Hobart is directed to an air duct screen cage and locking device therefore.

U.S. Pat. No. 2,944,631 to Kerry et al shows a retractable guard for a jet engine air intake formed of two sets of movable rods.

U.S. Pat. No. 3,333,794 to Lewis shows a jet engine air intake guard using a plurality of blades that project partially across the air flow.

U.S. Pat. No. 3,426,981 to Allcock shows a guard for a gas turbine engine. One version is formed by a series of radial vanes. A second version uses parallel vanes.

U.S. Pat. No. 3,871,844 to Calvin uses a screen apparatus to prevent ingestion of birds into a jet engine. The screen extends in front of the engine at an oblique angle. The forward portion is a solid nose cone that deflects objects away.

U.S. Pat. No. 6,138,950 to Wainfan et al relates to an aircraft engine air intake over using multiple air induction ducts shaped to control the air velocity profile in the air intake.

U.S. Pat. No. 6,883,751 to Koncsek relates to a foreign object deflector that is extended across the air intake of the engine.

### SUMMARY OF THE INVENTION

The present invention is directed to jet engine bird and debris shield devices and represents an improvement over the known prior art. Modern jet engines are capable of digesting small birds without malfunction. Larger birds become more of a problem. The shield of the present invention is specifically designed to deflect large birds, such as geese weighing in excess of eight pounds, from entering the turbine blades of a jet engine.

The shield structure attaches to the air intake portion of the jet engine and is designed to be an attractive ornamentation adding to the beauty of the aircraft. The device is aerodynamically shaped in the form of a solid frustro-conical cylinder having an open, proximate end sized to fit the cowling of the jet engine intake and a closed distal end pointed in the direction of the aircraft during a normal flight pattern. The shape is designed to act as a deflector of any material impacting against the shield with the exception of a direct hit.

The shield device is formed using aircraft grade aluminum of substantial thickness in order to withstand impacts from large objects. The shield is formed with a series of openings or slots that allow sufficient air to be entrained into the jet engine intake. The orientation and shape of the slots direct the air directly to the turbine blades so that the engine operates efficiently thus saving fuel during normal flight conditions.

In a preferred embodiment, the openings are a series of elongated slots extending from the closed front end of the shield device to the rear proximate end adjacent the attachment to the air intake cowling of the jet engine. In this embodiment the slots are equally sized and are located in a general parallel arrangement. The slots flare outwardly toward the jet engine. The land areas of the shield body between the slots are wider than the slots. This structure creates increased integrity and strength of the shield in order that it may withstand a substantial impact without deforming. The slots may be provided with additional air directing surfaces to more efficiently deliver the intake air to the engine.

Among the objects of the present invention is the provision of a shield for the air intake of a jet engine.

Another object of the present invention is the provision of a shield to prevent large flying birds from being ingested into the air intake of a jet engine.

Still another object is the provision of a shield that is designed to deflect material away from the air intake of a jet engine.

Another object of the present invention is the provision of an air intake shield for a jet engine having an aerodynamic shape configured to reduce engine drag during normal aircraft flight.

These and other objects will be appreciated with reference to the following specification and drawings.

### DRAWINGS

### Figures

FIG. 1 shows a perspective view of an air intake shield in accordance with the present invention.

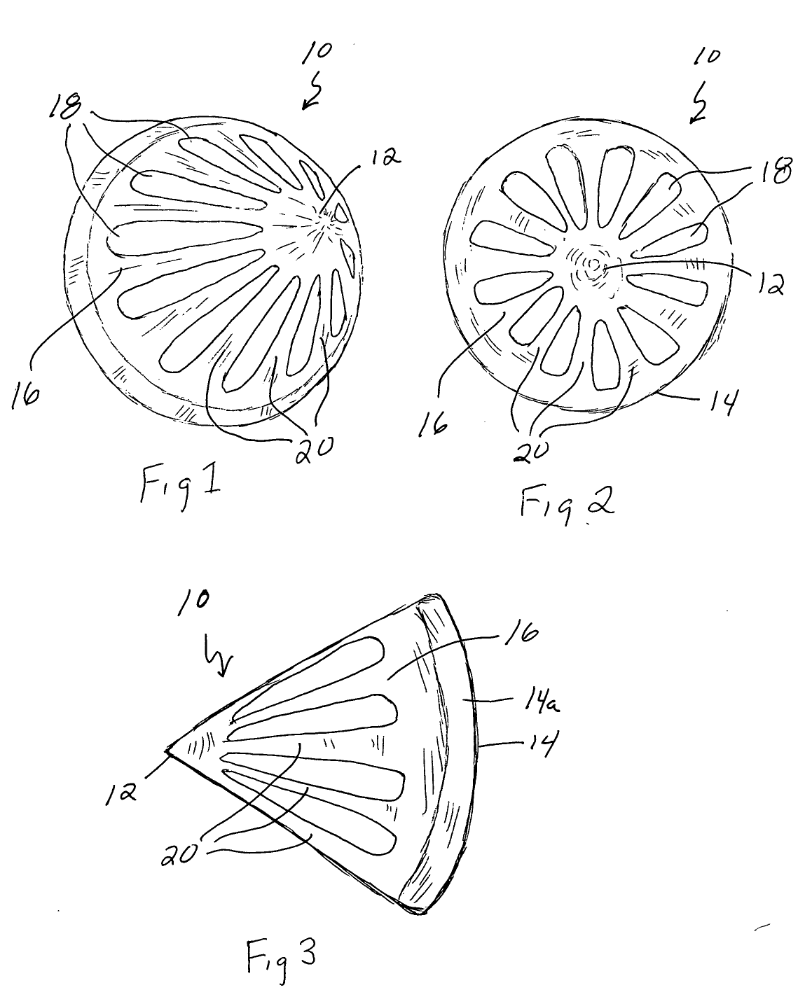

FIG. 2 is a front end view of the air intake shield of FIG. 1.

FIG. 3 is an elevational view of the shield of FIG. 1.

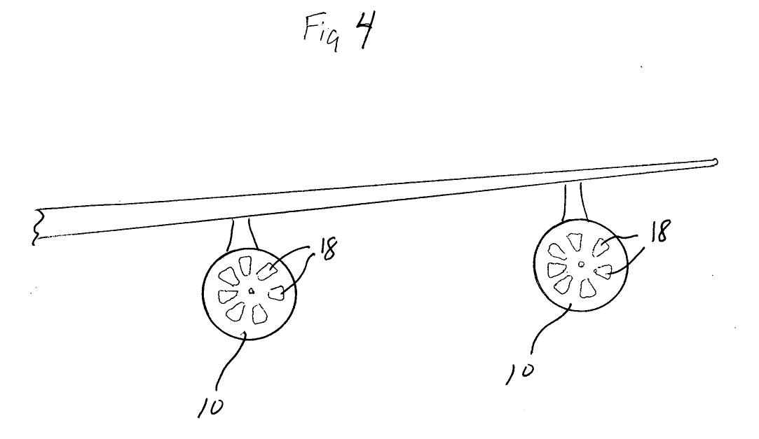

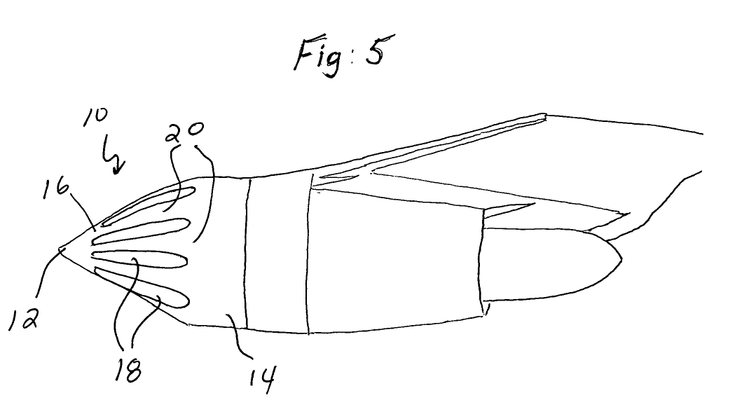

FIG. 4 is a view showing the shields mounted on a conventional aircraft engine.

FIG. 5 is another view of the shields mounted on aircraft engines.

### DETAILED DESCRIPTION

### FIGS. 1 to 5—Preferred Embodiment

Referring to the drawings, FIGS. 1 to 5 illustrate a first embodiment of jet engine air intake shield 10 of the present invention. The shield 10 is formed of aircraft strength aluminum with a frustro-conical, aerodynamic shape. The forward or distal end 12 is closed and forms a generally pointed surface in the direction that an aircraft will travel during normal flight. The rear or proximate end 14 is open and shaped to conform to the air opening of a jet engine. In this embodiment, the end 14 is flattened into a cylindrical shape to facilitate connection to a majority of jet engine shapes. The body 16 of the shield 10 between the closed forward end 12 and the open rear end 14 has a smooth shape that presents minimum air resistance when mounted on the front of a jet engine.

The shield 10 is formed with a series of elongated air slots 18 in a front to rear direction on the body 16 of the shield 10 between the forward end 12 and the rear end 14. The slots 18 are generally parallel to each other and are at least three times longer than the width thereof. In this embodiment, the length of the slots 18 is greater than half the distance between the distal end 12 and the proximate end 14 of the shield 10. The slots 18 are spaced from each other such that the land areas 20 of the air intake shield 10 between the slots 18 are larger than the width of the adjoining slot 18 and preferably can be up to three times larger. This provides structural integrity to the shield 10 and virtually eliminates deformation of the shield 10 should a significant impact occur. Each slot 18 is approximately one inch wide adjacent the forward end 12. The width of each slot 18 flares outwardly up to a width of approximately three inches adjacent the rear end 14 of the shield 10.

The slots 18 are designed to direct a sufficient air flow directly into the jet engine air intake while providing a formative barrier to large birds and the like that could be entrained into the air intake of the jet engine.

The drawings are illustrative only and show a series of 12 slots 18, whereas the size of the jet engine air intake opening will determine the actual number of slots 18 required to symmetrically fill the surface of the shield 10. The width of the slots 18 is sufficient to allow adequate air flow to the engine but narrow enough to prevent the ingestion of a goose or a similar large bird. Preferably the slots are no wider than three inches, this size being sufficient to prevent ingestion of a large bird. Smaller birds normally do not present serious problems since they are usually chewed up by the turbine blades without ill effect. The conical shape of the shield 10 in most cases will deflect any large bird that strikes the shield 10. Even a more direct strike will be deflected since only a minimum amount of material can enter the slots 18.

In the present embodiment, a series of twelve slots 18 are used with the configuration of the shield 10. It is contemplated that more or less slots may be used in keeping with the air intake requirements of a particular aircraft engine. Typically a shield 10 for a large commercial aircraft will use a shield 10 having upward of 30 to 40 slots and perhaps more depending upon the size of the engine.

FIGS. 4 and 5 illustrate the shield 10 of the present invention mounted on the air intake section of a commercial jet engine. It will be appreciated that various mounting structures may be used such as directly welding the shield to the air intake cowling, connecting with suitable locking devices and so forth.

It will be appreciated that various configurations of longitudinal slots may be used in keeping within the spirit and scope of the present invention as defined in the claims. Other modifications may include covering each slot with a fine metal mesh to prevent smaller objects of debris from entering the slots of the air intake shield.

### DRAWINGS

### Reference Numerals

| | |
|---|---|
| 10 | shield |
| 12 | forward end |
| 14 | rear end |
| 14a | end |
| 16 | body |
| 18 | slots |
| 20 | land areas |

I claim:

1. An aircraft, jet engine, air intake shield to eliminate debris and large birds from entering the jet engine comprising:
A frustro-conical body having a closed end in the direction of flight of said aircraft and an open end for attachment to the air intake of said aircraft;
Said shield further characterized by a series of elongated slots located between land areas on said frustro-conical shield; said slots located in a direction between said closed end and said open end of said shield; said slots being generally parallel each to the other; said slots serving to direct air into said jet engine air intake.

2. The shield of claim 1 wherein said slots are further defined as having a length exceeding half the distance between said closed end and said open end.

3. The shield of claim 1 wherein said closed end is cylindrical to facilitate connection to the air intake of said jet engine.

4. The shield of claim 1 wherein said slots are at least three times longer in a longitudinal direction from the closed end of said shield to the open end thereof than the width of said slots.

5. The shield of claim 1 wherein said slots are wider at the rear open end of said shield and narrower at the forward closed end.
